(19) United States
(12) Patent Application Publication
(10) Pub. No.: US 2015/0077608 A1
(43) Pub. Date: Mar. 19, 2015

(54) SOLID-STATE IMAGING DEVICE

(71) Applicant: Kabushiki Kaisha Toshiba, Minato-ku (JP)

(72) Inventor: Satoshi SAKURAI, Kawasaki-shi (JP)

(73) Assignee: Kabushiki Kaisha Toshiba, Minato-ku (JP)

(21) Appl. No.: 14/186,155

(22) Filed: Feb. 21, 2014

(30) Foreign Application Priority Data
Sep. 13, 2013 (JP) 2013-190398

(51) Int. Cl. H04N 5/335

(52) U.S. Cl. CPC H04N 5/335
USPC 348/302

(57) ABSTRACT

According to one embodiment, a solid-state imaging device includes a pixel array unit, a column ADC circuit, and a timing control circuit. The pixel array unit includes pixels that stores photoelectrically converted charges, and that are arranged in a matrix. The column ADC circuit calculates an AD conversion value of a pixel signal read from the pixel for each column based on a comparison result between the pixel signal and a reference voltage. The timing control circuit controls a distribution of an output timing of the comparison result between the columns.

### CROSS-REFERENCE TO RELATED APPLICATIONS

This application is based upon and claims the benefit of priority from Japanese Patent Application No. 2013-190398, filed on Sep. 13, 2013; the entire contents of which are incorporated herein by reference.

### FIELD

Embodiments described herein relate generally to a solid-state imaging device.

### BACKGROUND

Some solid-state imaging devices use a column AD converter in order to shorten a processing time upon an AD conversion of a pixel signal read from a pixel.

### BRIEF DESCRIPTION OF THE DRAWINGS

FIG. 1 is a block diagram illustrating a schematic configuration of a solid-state imaging device according to a first embodiment;

FIG. 2 is a circuit diagram illustrating an example of a configuration of a pixel in the solid-state imaging device in FIG. 1;

FIG. 3 is a circuit diagram illustrating an example of a configuration of a reference voltage generating circuit and a column ADC circuit in FIG. 1;

FIG. 4 is a timing chart illustrating a voltage waveform of each unit during a reading operation of the pixel in FIG. 1;

FIG. 5 is a circuit diagram illustrating an example of a configuration of an inter-column short circuit in FIG. 1;

FIG. 6A is a timing chart illustrating a voltage waveform of each unit in the solid-state imaging device in FIG. 1 when short-circuiting between columns is not generated before an analog sampling;

FIG. 6B is a timing chart illustrating a voltage waveform of each unit in the solid-state imaging device in FIG. 1 when short-circuiting between columns is generated before an analog sampling;

FIG. 7A is a timing chart illustrating a relationship between an output from a subject comparator and outputs from other comparators when short-circuiting between columns is not generated before the analog sampling;

FIG. 7B is a timing chart illustrating a relationship between an output from a subject comparator and outputs from other comparators when short-circuiting between columns is generated before the analog sampling; and

FIG. 8 is a block diagram illustrating a schematic configuration of a digital camera to which a solid-state imaging device according to a second embodiment is applied.

### DETAILED DESCRIPTION

According to one embodiment, a solid-state imaging device includes a pixel array unit, a column ADC circuit, and a timing control circuit. The pixel array unit includes pixels that stores photoelectrically converted charges, and that are arranged in a matrix. The column ADC circuit calculates an AD conversion value of a pixel signal read from the pixel for each column based on a comparison result between the pixel signal and a reference voltage. The timing control circuit controls a distribution of an output timing of the comparison result between the columns.

A solid-state imaging device according to an embodiment will be described below in detail with reference to the accompanying drawings. The invention is not limited to the embodiments.

### First Embodiment

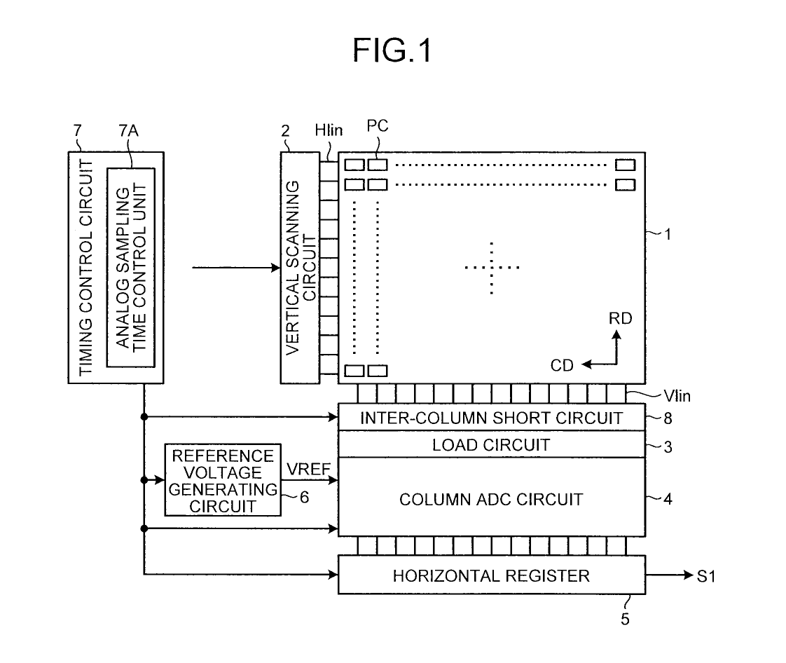

FIG. 1 is a block diagram illustrating a schematic configuration of a solid-state imaging device according to a first embodiment.

In FIG. 1, the solid-state imaging device includes a pixel array unit 1. The pixel array unit 1 includes m (m is a positive integer)×n (n is a positive integer) pixels PC, which store photoelectrically converted charges, in a row direction RD and a column direction CD in a matrix. The pixel array unit 1 also includes horizontal control lines Hlin that are arranged in the row direction RD for performing a reading control of the pixel PC and vertical signal lines Vlin that are arranged in the column direction CD for transmitting signals read from the pixel PC.

The solid-state imaging device also includes a vertical scanning circuit 2 that scans the pixel PC, which is the subject to be read, in the vertical direction, a load circuit 3 that reads a pixel signal Vsig on the vertical signal line Vlin from the pixel PC for each column by performing a source follower operation with the pixel PC, a column ADC circuit 4 that calculates an AD conversion value of the pixel signal Vsig according to CDS for each column based on a comparison result between the pixel signal Vsig and a reference voltage VREF, a horizontal register 5 that transfers the AD conversion value calculated by the column ADC circuit 4 in the horizontal direction, a reference voltage generating circuit 6 that outputs a reference voltage VREF to the column ADC circuit 4, a timing control circuit 7 that controls a timing of reading and storing each pixel PC, and an inter-column short circuit 8 that makes the vertical signal line Vlin short-circuited between columns before analog sampling. The reference voltage VREF can use a ramp wave. The column ADC circuit 4 can perform analog sampling for compensating variation in an output potential of the pixel signal Vsig. The timing control circuit 7 can control distribution of an output timing of the comparison result between the pixel signal Vsig and the reference voltage VREF between columns. The variation in the output potential of the pixel signal Vsig can be used to control the distribution between columns. The timing control circuit 7 includes an analog sampling time control unit 7A that controls a time from when the short-circuiting between columns is canceled till the analog sampling.

The pixel PC is selected in the row direction RD by the scan of the pixel PC in the vertical direction by the vertical scanning circuit 2. The load circuit 3 performs the source follower operation with the pixel PC, whereby the pixel signal Vsig read from the pixel PC is transferred via the vertical signal line Vlin, and sent to the column ADC circuit 4. The reference voltage generating circuit 6 sets a ramp wave as the reference voltage VREF, and this ramp wave is sent to the column ADC circuit 4. The column ADC circuit 4 performs a counting operation of a clock until a level of a signal read from the pixel PC and a reset level agree with a level of the ramp wave. The difference between the signal level and the reset level in this case is obtained, whereby a signal component of each pixel PC is converted into a digital value according to the CDS, and the digital value is transferred in the horizontal direction via the horizontal register 5, and output as an output signal S1.

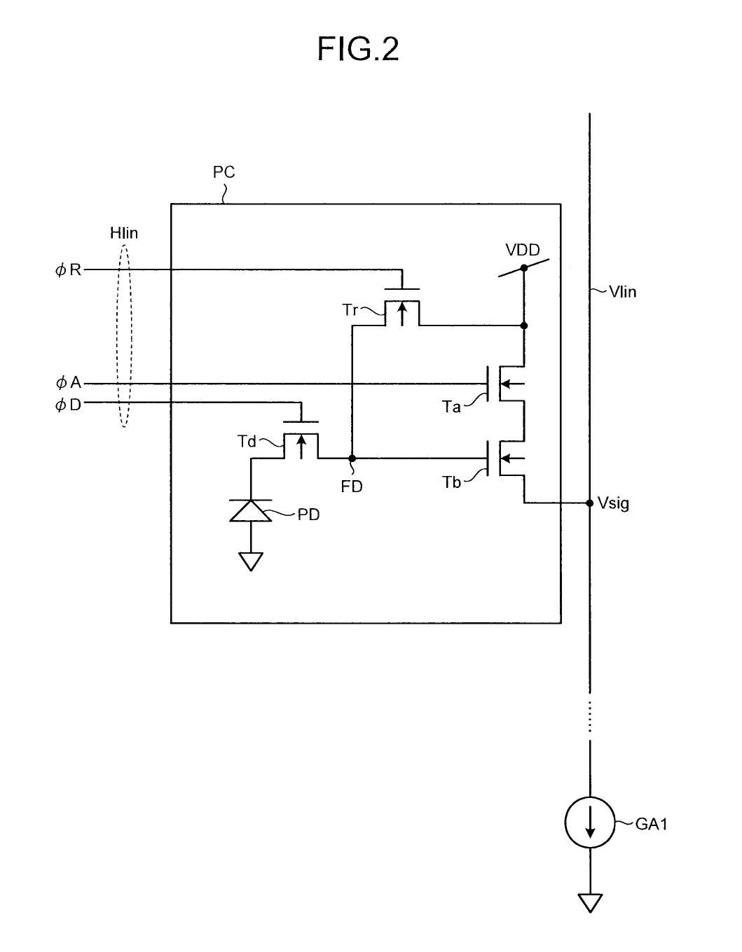

FIG. 2 is a circuit diagram illustrating an example of a configuration of a pixel in the solid-state imaging device in FIG. 1.

In FIG. 2, each pixel PC includes a photodiode PD, a row selection transistor Ta, an amplifier transistor Tb, a reset transistor Tr, and a reading transistor Td. A floating diffusion FD serving as a detection node is formed on a connection point of the amplifier transistor Tb, the reset transistor Tr, and the reading transistor Td.

In the pixel PC, a source of the reading transistor Td is connected to the photodiode PD, and a reading signal ΦD is input to a gate of the reading transistor Td. A source of the reset transistor Tr is connected to a drain of the reading transistor Td, a reset signal ΦR is input to a gate of the reset transistor Tr, and a drain of the reset transistor Tr is connected to a power supply potential VDD. A row selection signal ΦA is input to a gate of the row selection transistor Ta, and a drain of the row selection transistor Ta is connected to the power supply potential VDD. A source of the amplifier transistor Tb is connected to the vertical signal line Vlin, a gate of the amplifier transistor Tb is connected to a drain of the reading transistor Td, and a drain of the amplifier transistor Tb is connected to a source of the row selection transistor Ta. The horizontal control line Hlin in FIG. 1 can transfer the reading signal ΦD, the reset signal ΦR, and the row selection signal ΦA to the pixel PC for each row. A constant current source GA1 is provided to the load circuit 3 in FIG. 1 for each column, and the constant current source GA1 is connected to the vertical signal line Vlin. The variation in a threshold voltage of the amplifier transistor Tb between columns causes the variation in the output potential of the pixel signal Vsig between columns.

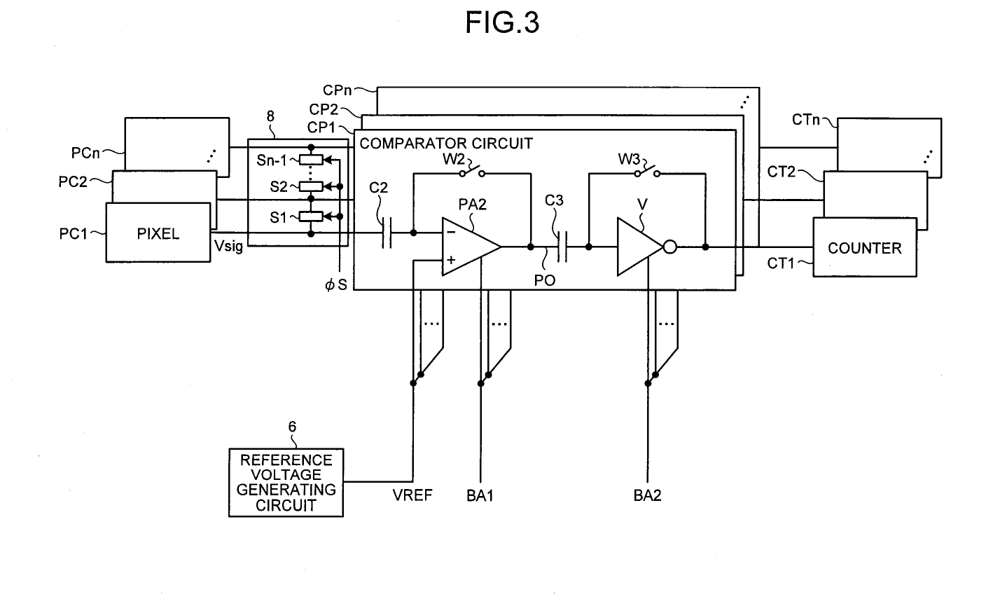

FIG. 3 is a circuit diagram illustrating an example of the configuration of the reference voltage generating circuit and the column ADC circuit in FIG. 1.

In FIG. 3, the column ADC circuit 4 includes comparator circuits CP1 to CPn and counters CT1 to CTn for each column. A binary counter with an inverting function can be used for the counters CT1 to CTn. The comparator circuits CP1 to CPn are respectively connected to pixels PC1 to PCn on the first column to the nth column. The comparator circuit CP1 includes capacitors C2 and C3, a comparator PA2, switches W2 and W3, and an inverter V. The capacitor C2 can perform analog sampling by holding charges corresponding to the difference between the reference voltage VREF and the output potential of the pixel signal Vsig for each column.

The vertical signal line Vlin is connected to an inverting input terminal of the comparator PA2 via the capacitor C2, while an output terminal of the reference voltage generating circuit 6 is connected to a non-inverting input terminal of the comparator PA2. The switch W2 is connected between the inverting input terminal and the output terminal of the comparator PA2. The output terminal of the comparator PA2 is connected to an input terminal of the inverter V via the capacitor C3, and the counter CT1 is connected to an output terminal of the inverter V. The switch W3 is connected between the inverting input terminal and the output terminal of the inverter V.

The inter-column short circuit 8 includes switches S1 to Sn−1 for generating short-circuiting on the vertical signal line Vlin between columns. Each of the switches S1 to Sn−1 are connected between the vertical signal lines Vlin of each column.

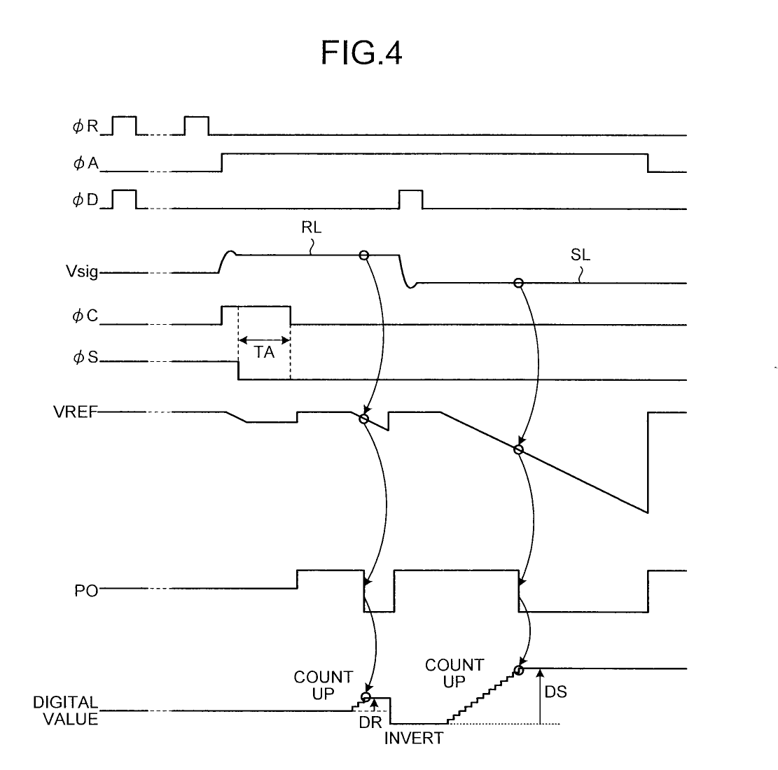

FIG. 4 is a timing chart illustrating a voltage waveform of each unit during a reading operation of the pixel in FIG. 1.

In FIG. 4, when the row selection signal ΦA is in a low level, the row selection transistor Ta is turned off, so that the source follower operation is not carried out. Accordingly, a signal is not output to the vertical signal line Vlin. In this case, when the reading signal ΦD and the reset signal ΦR are in a high level, the reading transistor Td is turned on, so that charges stored in the photodiode PD are discharged to the floating diffusion FD. The charges are then discharged to the power supply potential VDD via the reset transistor Tr.

When the reading signal ΦD becomes low level after the charges stored in the photodiode PD are discharged to the power supply potential VDD, the photodiode PD starts to store signal charges.

When the reset signal ΦR rises next, the reset transistor Tr is turned on, so that the surplus charges generated by leak current on the floating diffusion FD are reset.

When the row selection signal ΦA becomes a high level, the row selection transistor Ta of the pixel PC is turned on to apply the power supply potential VDD to the drain of the amplifier transistor Tb, whereby the amplifier transistor Tb and the constant current source GA1 form a source follower. The voltage according to the reset level RL of the floating diffusion FD is applied to the gate of the amplifier transistor Tb. Since the amplifier transistor Tb and the constant current source GA1 form the source follower, the voltage on the vertical signal line Vlin follows the voltage applied to the gate of the amplifier transistor Tb, whereby the pixel signal Vsig with the reset level RL is output to the column ADC circuit 4 via the vertical signal line Vlin.

When the pixel signal Vsig with the reset level RL is output to the vertical signal line Vlin, a reset pulse (DC is applied to the switch W2, and when the switch W2 is turned on, an input voltage on the inverting input terminal of the comparator PA2 is clamped by the output voltage PO, whereby an operating point is set. In this case, the analog sampling is performed since the charges corresponding to the differential voltage with the pixel signal Vsig from the vertical signal line Vlin are held in the capacitor C2, whereby the input voltage of the comparator PA2 is set to zero. When the reset pulse ΦC is applied to the switch W3 to turn on the switch W3, the input voltage of the input terminal of the inverter V is clamped by the output voltage, whereby an operating point is set. In this case, the charges corresponding to the differential voltage with the output signal from the inverter V are held in the capacitor C3, so that the input voltage of the inverter V is set to zero.

Since the switches S1 to Sn−1 are turned on due to the application of a short pulse (DS to the switches S1 to Sn−1 before the start of the analog sampling, the vertical signal line Vlin is short-circuited between columns. The switches S1 to Sn−1 are turned off by the falling of the short pulse ΦS, whereby the short-circuiting of the vertical signal line Vlin between columns is canceled. In this case, the analog sampling time control unit 7A controls the time from when the short-circuiting between columns is canceled till the end of the analog sampling. Therefore, the charging of the capacitor C2 is completed until charges for compensating the variation in the output potential of the pixel signal Vsig are sufficiently stored in the capacitor C2. Accordingly, in this analog sampling, the variation in the output potential of the pixel signal Vsig between columns can be reflected on the output from the comparator PA2, while allowing the variation in the output potential of the pixel signal Vsig between columns to fall within a predetermined range.

After the switches W2 and W3 are turned off, the ramp wave is applied as the reference voltage VREF with the state in which the pixel signal Vsig with the reset level RL is input to the comparator PA2 via the capacitor C2, and the pixel signal Vsig with the reset level RL and the reference voltage VREF are compared. The output voltage PO of the comparator PA2 is inverted by the inverter V, and then, input to the counter CT1.

The counter CT1 counts up until the pixel signal Vsig with the reset level RL agrees with the level of the reference voltage VREF, whereby the pixel signal Vsig with the reset level RL is converted into a digital value DR and held. Thereafter, the counter value stored in the binary counter is bit-inverted to be converted into a negative value for the succeeding calculation of the difference with a signal level.

When the reading signal ΦR rises next, the reading transistor Td is turned on, whereby charges stored in the photodiode PD are transferred to the floating diffusion FD, and the voltage according to a signal level SL of the floating diffusion FD is applied to the gate of the amplifier transistor Tb. Since the amplifier transistor Tb and the constant current source GA1 form the source follower, the voltage on the vertical signal line Vlin follows the voltage applied to the gate of the amplifier transistor Tb, whereby the pixel signal Vsig with the signal level SL is output to the column ADC circuit 4 via the vertical signal line Vlin.

The ramp wave is applied as the reference voltage VREF with the state in which the pixel signal Vsig with the signal level SL is input to the comparator PA2 via the capacitor C2 in the column ADC circuit 4, and the pixel signal Vsig with the signal level SL and the reference voltage VREF are compared. The output voltage PO of the comparator PA2 is inverted by the inverter V, and then, input to the counter CT1.

The counter CT1 counts up until the pixel signal Vsig with the signal level SL agrees with the level of the reference voltage VREF, whereby the pixel signal Vsig with the signal level SL is converted into a digital value DS. The difference DS−DR between the pixel signal Vsig with the reset level RL and the pixel signal Vsig with the signal level SL is held in the counter CT1, and output as the output signal S1.

The vertical signal line Vlin is short-circuited between columns before the start of the analog sampling, and the time TA from when the short-circuiting between columns is canceled till the end of the analog sampling is controlled. Accordingly, the variation in the output potential of the pixel signal Vsig can be reflected on the input of the comparator PA2 without invalidation of the analog sampling. Consequently, the inverting timing of the comparator PA2 can be distributed between columns according to the variation in the output potential of the pixel signal Vsig, and this configuration can prevent the inverting timings of a great number of comparators PA2 from agreeing with one another. As a result, noise caused by the simultaneous inversion of a great number of comparators PA2 can be reduced, whereby noise transmitted to the comparator PA2 on other column via a common power supply line or a common bias line between columns can be reduced. Consequently, streaking can be reduced.

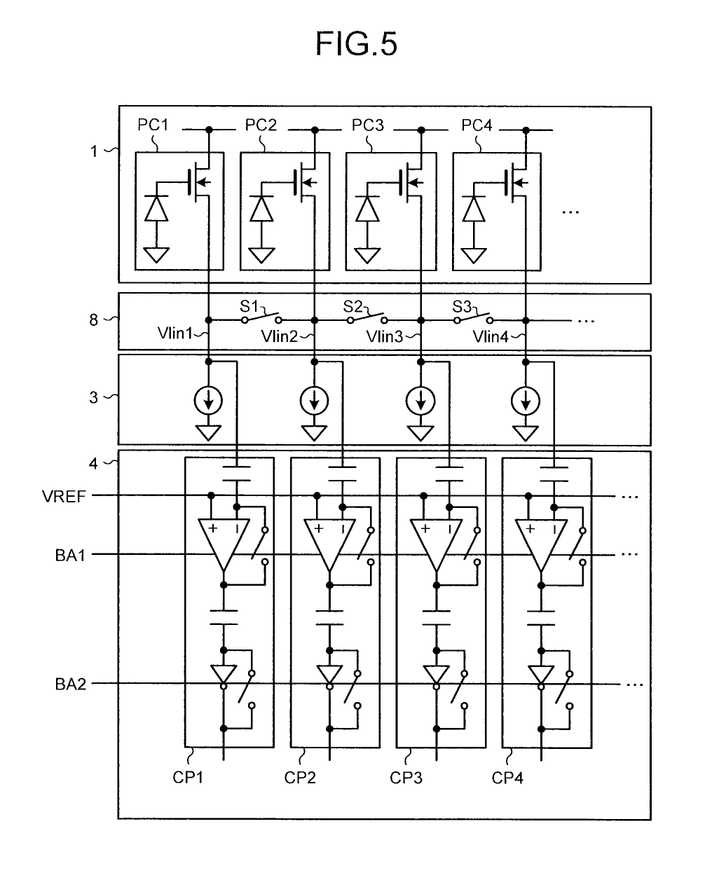

FIG. 5 is a circuit diagram illustrating an example of the configuration of the inter-column short circuit in FIG. 1.

In FIG. 5, pixels PC1 to PC4 are provided for each column, and the pixels PC1 to PC4 are respectively connected to the comparator circuits CP1 to CP4 via vertical signal lines Vlin 1 to Vlin 4. The switch S1 is connected between the vertical signal lines Vlin 1 and Vlin 2, the switch S2 is connected between the vertical signal lines Vlin 2 and Vlin 3, and the switch S3 is connected between the vertical signal lines Vlin 3 and Vlin 4. A bias line BA1 for supplying bias to the comparator PA2 is commonly provided to the comparator circuits CP1 to CP4, and a bias line BA2 for supplying bias to the inverter V is commonly provided to the comparator circuits CP1 to CP4.

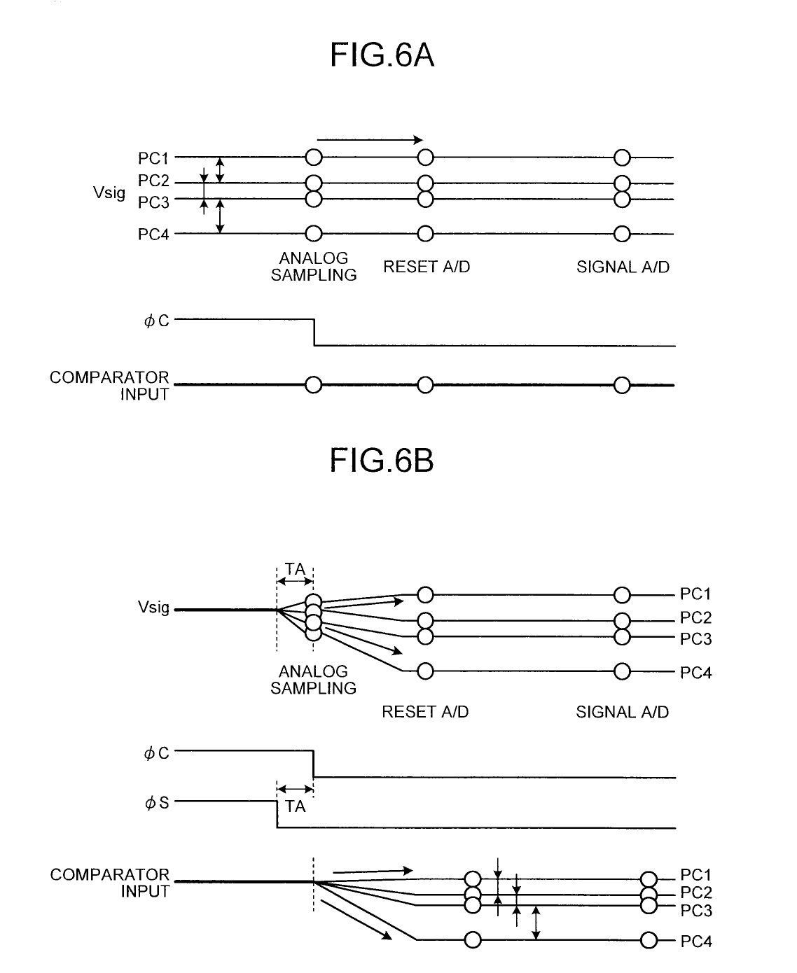

FIG. 6A is a timing chart illustrating a voltage waveform of each unit in the solid-state imaging device in FIG. 1 when short-circuiting between columns is not generated before an analog sampling, and FIG. 6B is a timing chart illustrating a voltage waveform of each unit in the solid-state imaging device in FIG. 1 when short-circuiting between columns is generated before an analog sampling.

In FIG. 6A, the output potentials of the pixel signals Vsig of the pixels PC1 to PC4 varies. The charges corresponding to the variation in the output potentials of the pixel signals Vsig are held in the capacitor C2 for each column by the execution of the analog sampling, whereby the reflection of the variation in the output potential of the pixel signal Vsig on the input of the comparator PA2 can be prevented.

On the other hand, in FIG. 6B, the output potentials of the pixel signals Vsig of the pixels PC1 to PC4 match due to the generation of the short-circuiting between columns. The time TA from when the short-circuiting between columns is canceled till the end of the analog sampling is set to a time before the input of the comparator PA2 converges for each of the pixels PC1 to PC4, whereby the variation in the output potential of the pixel signal Vsig can be reflected on the input of the comparator PA2, while allowing the variation in the output potential of the pixel signal Vsig to fall within a predetermined range. Consequently, the inverting timing of the comparator PA2 can be distributed between columns according to the variation in the output potential of the pixel signal Vsig, and this configuration can prevent the inverting timings of a great number of comparators PA2 from agreeing with one another.

The variation in the output potential of the pixel signal Vsig is equally reflected on the digital value DR with the reset level RL and the digital value DS with the signal level SL. Therefore, the difference DR−DS between the digital value DR with the reset level RL and the digital value DS with the signal level SL is output as the output signal S1, whereby the variation in the output potential of the pixel signal Vsig can be eliminated.

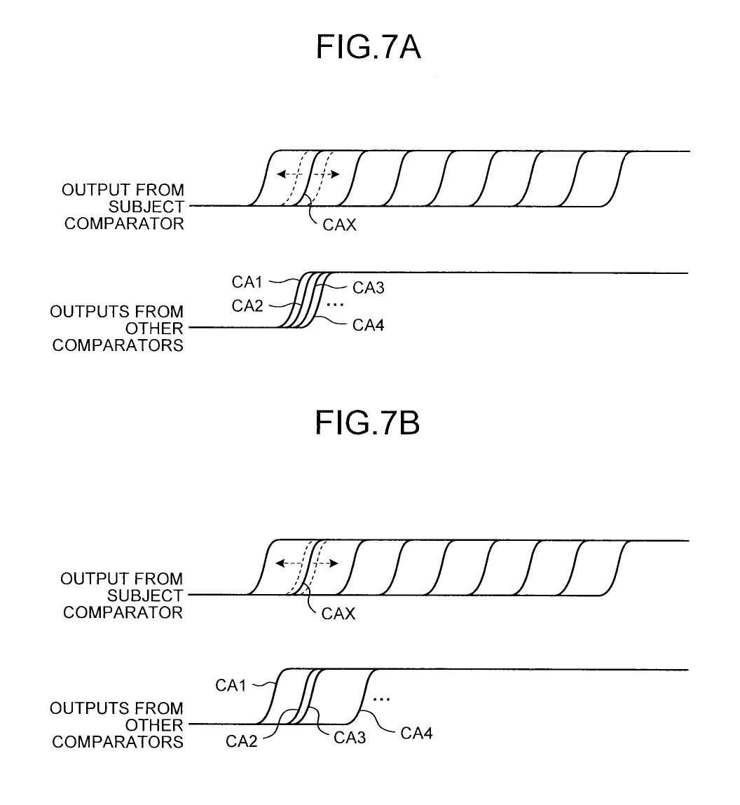

FIG. 7A is a timing chart illustrating a relationship between an output from a subject comparator and outputs from other comparators when short-circuiting between columns is not generated before the analog sampling, and FIG. 7B is a timing chart illustrating a relationship between the output from the subject comparator and the outputs from other comparators when the short-circuiting between columns is generated before the analog sampling.

As illustrated in FIG. 7A, when a comparator for a certain column is specified as a subject column CAX upon the detection of the reset level, the outputs from a great number of other columns CA1 to CA4 are inverted almost simultaneous with the subject column CAX. Therefore, the inverting timing of the subject column CAX is greatly shifted forward and backward due to the great influence of noise caused by the simultaneous inversion. On the other hand, upon the detection of the signal level, noise amount received from other columns greatly changes, since a light quantity of a pixel from each column is different, and the number of the column comparator simultaneously inverting is different. The variation in the output level of the subject column CAX to the change in the noise amount is observed as streaking.

On the other hand, as illustrated in FIG. 7B, when the inverting timings of the comparator outputs of a great number of other columns CA1 to CA4 are distributed upon the detection of the reset level, the noise caused by the inversion is reduced. Therefore, the noise transmitted to the comparator of the subject column CAX becomes small, so that the forward and backward shift of the inverting timing of the comparator of the subject column CAX can be reduced. Thus, the noise amount received from other columns during the detection of the reset level and the detection of the signal level is reduced, whereby the variation in the output level of the subject column CAX dependent upon the change in the signal level of the column is reduced. Accordingly, streaking is improved.

### Second Embodiment

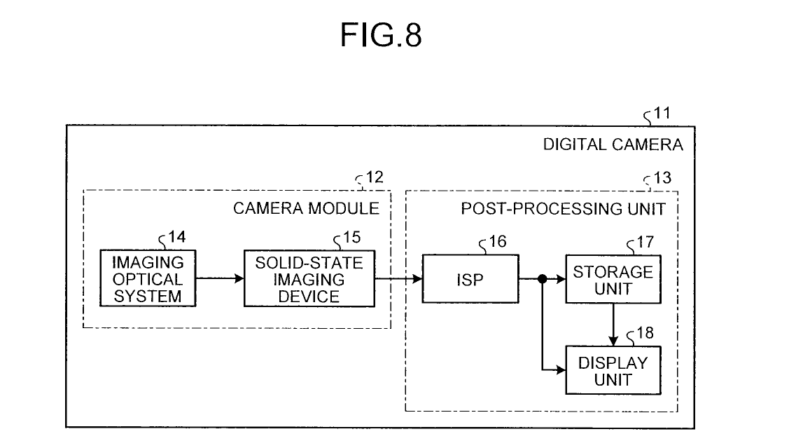

FIG. 8 is a block diagram illustrating a schematic configuration of a digital camera to which a solid-state imaging device according to a second embodiment is applied.

In FIG. 8, a digital camera 11 includes a camera module 12 and a post-processing unit 13. The camera module 12 includes an imaging optical system 14 and a solid-state imaging device 15. The post-processing unit 13 includes an image signal processor (ISP) 16, a storage unit 17, and a display unit 18. The configuration illustrated in FIG. 1 can be employed to form the solid-state imaging device 15. At least a partial configuration of the ISP 16 may be formed as one chip together with the solid-state imaging device 15.

The imaging optical system 14 receives light from a subject, and forms a subject image. The solid-state imaging device 15 images the subject image. The ISP 16 performs signal processing on an image signal obtained by the imaging by the solid-state imaging device 15. The storage unit 17 stores the image that has undergone the signal processing at the ISP 16. The storage unit 17 outputs the image signal to the display unit 18 in conformity with a user operation or the like. The display unit 18 displays the image in conformity with the image signal received from the ISP 16 or the storage unit 17. The display unit 18 is, for example, a liquid crystal display. The camera module 12 is applied to, besides the digital camera 11, electronic equipment such as a portable terminal with an incorporated camera.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A solid-state imaging device comprising:
a pixel array unit including pixels that store photoelectrically converted charges, and that are arranged in a matrix;
a reference voltage generating circuit that generates a reference voltage;
a column ADC circuit that includes a comparator comparing a pixel signal read from the pixel and the reference voltage, and calculates an AD conversion value of the pixel signal based on a comparison result by the comparator for each of the column;
a vertical signal line that transfers the pixel signal for each of the columns;
a capacitor that holds a charge corresponding to the pixel signal of a reset level for each of the columns so as to perform an analog sampling;
an inter-column short circuit that makes the vertical signal line short-circuited between the columns before the analog sampling; and
an analog sampling time control unit that controls a time from when a short-circuiting between the columns is canceled till the analog sampling.

2. The solid-state imaging device according to claim 1, wherein the time from when the short-circuiting between the columns is canceled till the analog sampling is set to a time before an input of the comparator converges for each pixel.

3. The solid-state imaging device according to claim 1, wherein the inter-column short circuit includes a switch that makes the vertical signal line short-circuited between the columns.

4. The solid-state imaging device according to claim 1, wherein the distribution of the output timing of the comparison result by the comparator between the columns is controlled based on a variation in an output potential of the pixel signal.

5. The solid-state imaging device according to claim 4, wherein
the pixel includes:
a photodiode that performs photoelectric conversion;
a reading transistor that transfers a signal to a floating diffusion from the photodiode;
a reset transistor that resets a signal stored in the floating diffusion; and
an amplifier transistor that detects a potential of the floating diffusion.

6. The solid-state imaging device according to claim 4, wherein the column ADC circuit cancels a variation in an output potential of the pixel signal by obtaining a difference between an AD conversion value with a reset level and an AD conversion value with a signal level.

7. A solid-state imaging device comprising:
a pixel array unit including pixels that store photoelectrically converted charges, and that are arranged in a matrix;
a column ADC circuit that calculates an AD conversion value of a pixel signal, read from the pixel, for each of the column based on a comparison result between the pixel signal and a reference voltage; and
a timing control circuit that controls a distribution of an output timing of the comparison result between the columns.

8. The solid-state imaging device according to claim 7, wherein the distribution of the output timing of the comparison result between the columns is controlled based on a variation in an output potential of the pixel signal.

9. The solid-state imaging device according to claim 8, comprising:
a vertical signal line that transfers the pixel signal for each of the columns;
an analog sampling unit that performs an analog sampling for compensating a variation in an output potential of the pixel signal; and
an inter-column short circuit that makes the vertical signal line short-circuited between the columns before the analog sampling.

10. The solid-state imaging device according to claim 9, wherein the timing control circuit includes an analog sampling time control unit that controls a time from when the short-circuiting between the columns is canceled till the analog sampling.

11. The solid-state imaging device according to claim 10, wherein the inter-column short circuit includes a switch that makes the vertical signal line short-circuited between the columns.

12. The solid-state imaging device according to claim 7, wherein the column ADC circuit cancels a variation in an output potential of the pixel signal by obtaining a difference between an AD conversion value with a reset level and an AD conversion value with a signal level.

13. The solid-state imaging device according to claim 12, wherein the column ADC circuit includes:
a comparator circuit that compares a pixel signal read from the pixel and the reference voltage; and
a counter that performs a counting operation until the pixel signal agrees with a level of the reference voltage.

14. The solid-state imaging device according to claim 13, wherein the comparator circuit includes:
a comparator;
a switch; and
a capacitor that holds a charge corresponding to the pixel signal of the reset level for each of the columns so as to perform an analog sampling, wherein
an inverting input terminal of the comparator is connected to the vertical signal line through the capacitor, the switch is connected between the inverting input terminal and an output terminal of the comparator, and the reference voltage is input to a non-inverting input terminal of the comparator.

15. The solid-state imaging device according to claim 14, wherein the switch is turned on when the pixel signal is output to the vertical signal line so as to hold a charge according to a pixel signal from the vertical signal line in the capacitor.
